(19) United States
(12) Patent Application Publication
(10) Pub. No.: US 2006/0220617 A1
(43) Pub. Date: Oct. 5, 2006

(54) Hand-held pen-shaped spotlight with dedicated charger socket

(76) Inventor: Se Kit Yuen, Hong Kong (HK)

Correspondence Address: AKERMAN SENTERFITT, P.O. BOX 3188, WEST PALM BEACH, FL, 33402-3188, US

(21) Appl. No.: 11/311,982

(22) Filed: Dec. 20, 2005

(30) Foreign Application Priority Data
Mar. 30, 2005 (CN) 200520011014.X

(51) Int. Cl. H02J 7/00

(52) U.S. Cl. 320/137

(57) ABSTRACT

The present invention discloses hand-held pen-shaped spotlights and a dedicated charger socket for the same. An object of the present invention is to overcome the disadvantages occurred in prior art that the conventional hand-held pen-shaped spotlight and dedicated charger socket for the same can not be used by a user conveniently and alternatively. The dedicated charger socket is provided with two recessed grooves so as to adapt to two hand-held pen-shaped spotlights. The present invention can be used widely in medical field and daily life.

### TECHNICAL FIELD OF THE INVENTION

The present invention relates to hand-held pen-shaped spotlights and a dedicated charger socket for the same.

### BACKGROUND ART OF THE INVENTION

The conventional hand-held pen-shaped spotlight generally has a cylindrical structure and a large volume, so that it is inconvenient for use. Particularly, the charging circuit of the chargeable spotlight is provided in a body of the spotlight, so that the body can not be designed so as to have a small volume. In addition, in some special usage environments, the spotlight is required to focus light beams and to be convenient for hand-holding or fixing, however, the conventional hand-held spotlight can not meet the above requirements. Considering the above disadvantages, the Chinese Utility model Application No. 032764465.4 disclosed a hand-held pen-shaped spotlight and a dedicated charger socket for the same, the hand-held pen-shaped spotlight overcomes the above disadvantages occurred in the conventional spotlight that has a big volume, can not focus the light beams and is inconvenient for use. However, the dedicated charger socket can not charge two hand-held pen-shaped spotlights simultaneously and only one hand-held pen-shaped spotlight adapted to the dedicated charger socket is provided. Therefore, it can not meet the requirements that two hand-held pen-shaped spotlights can be used conveniently and alternatively by a user.

### SUMMARY OF THE INVENTION

In order to overcome the shortcomings in the prior art, an object of the present invention is to provide a dedicated charger socket capable of charging two hand-held pen-shaped spotlights simultaneously, and also to provide two hand-held pen-shaped spotlights adapted to the dedicated charger socket.

In order to accomplish the above object, in a first aspect of the present invention, there is provided a dedicated charger socket for hand-held pen-shaped spotlights, comprising a base, a charging body connected fixedly to the base, an inner chamber provided with a transformer and a charging circuit arrangement therein, alternating current (AC) connector pins capable of being directly inserted into a commercial power supply jack, and two recessed grooves adapted to hand-held pen-shaped spotlights so as to charge the hand-held pen-shaped spotlights.

Preferably, two charging indicator lamps corresponding to the recessed grooves are provided for indicating the charging state of the recessed grooves, respectively.

In a second aspect of the present invention, there is provided a hand-held pen-shaped spotlight. The hand-held pen-shaped spotlight may be charged by using the dedicated charger socket according to the first aspect of the present invention, in which the number of hand-held pen-shaped spotlights is two so that the two hand-held pen-shaped spotlights are adapted to the dedicated charger socket.

The present invention has the following advantageous effects:

1. A user can use the hand-held pen-shaped spotlight conveniently, alternatively and continuously, that is, when one of the two hand-held pen-shaped spotlights is used, the other can be charged, so that the hand-held pen-shaped spotlight can be kept in the brightest operating state.

2. The two hand-held pen-shaped spotlights can be used by two users simultaneously.

### BRIEF DESCRIPTION OF THE DRAWINGS

The above and other objects and advantages of the present invention will become more apparent from the detailed description of the embodiments with reference to the drawings, in which:

FIG. 1 is a front view showing a charging state of the present invention;

FIG. 2 is a rear view showing a charging state of the present invention;

FIG. 3 is a left view showing a charging state of the present invention;

FIG. 4 is a right view showing a charging state of the present invention;

FIG. 5 is a top view showing a charging state of the present invention;

FIG. 6 is a bottom view showing a charging state of the present invention;

FIG. 7 is a perspective view showing a charging state of the present invention;

FIG. 8 is another perspective view showing a charging state of the present invention;

FIG. 9 is a perspective view showing a separated state in which the hand-held pen-shaped spotlights are separated from the dedicated charger socket.

### DETAILED DESCRIPTION OF THE PREFERRED EMBODIMENTS OF THE INVENTION

A dedicated charger socket for hand-held pen-shaped spotlights according to an embodiment of the present invention comprises a base, a charging body connected fixedly to the base, an inner chamber provided with a transformer and a charging circuit arrangement therein, alternating current (AC) connector pins capable of being directly inserted into a commercial power supply jack, and two recessed grooves adapted to hand-held pen-shaped spotlights so as to charge the hand-held pen-shaped spotlights.

A hand-held pen-shaped spotlight according to an embodiment of the present invention has a pen shape and the number thereof is two. Further, the hand-held pen-shaped spotlight is provided with a clip for securing the hand-held pen-shaped spotlight to a pocket conveniently, in addition, the clip can also be used as a power switch, so that the hand-held pen-shaped spotlight can be powered to illuminate when the clip is pressed slightly.

It should be stated that the base, the charging body, the transformer, the charging circuit arrangement and the inner chamber are not shown or not shown definitely in the drawings since they are well known and conventional, and their structural features can be known from the closest prior art to the present invention, so that their detailed descriptions are omitted here. The improved structures of the present invention will be described with reference to the drawings as follows.

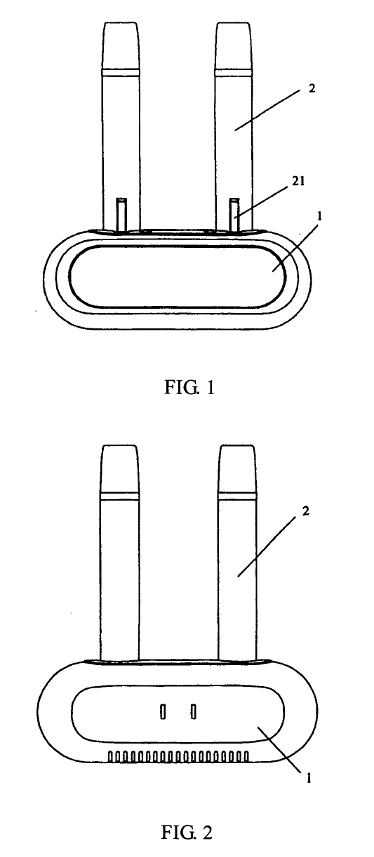

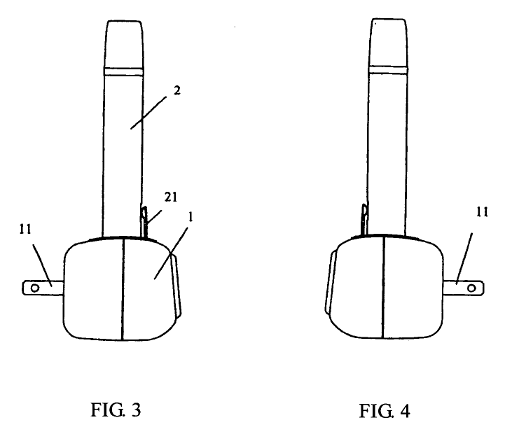

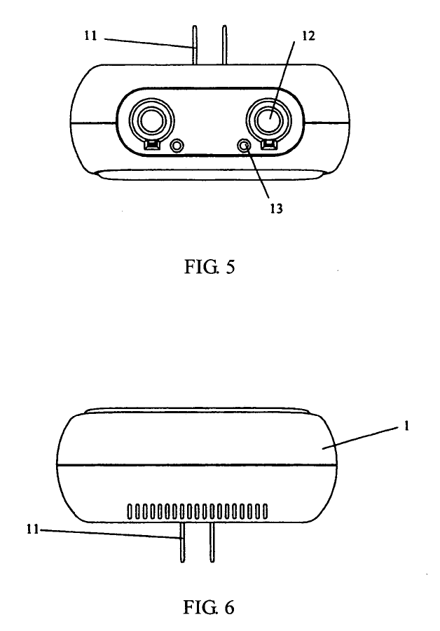

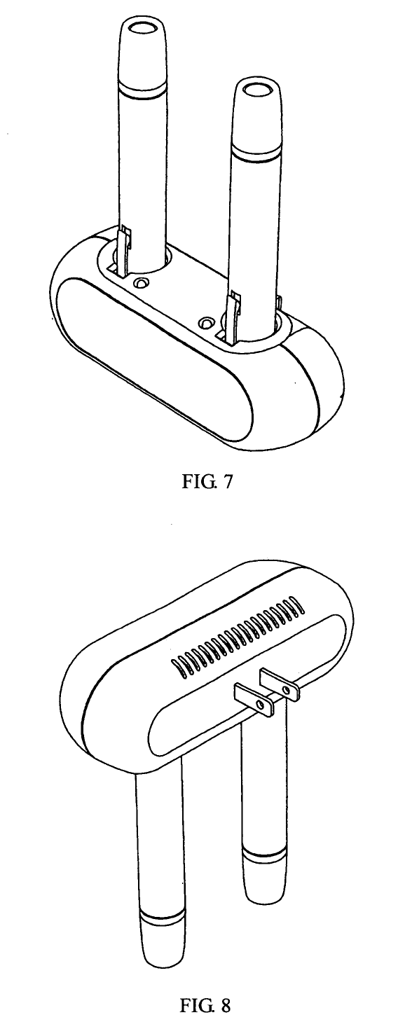

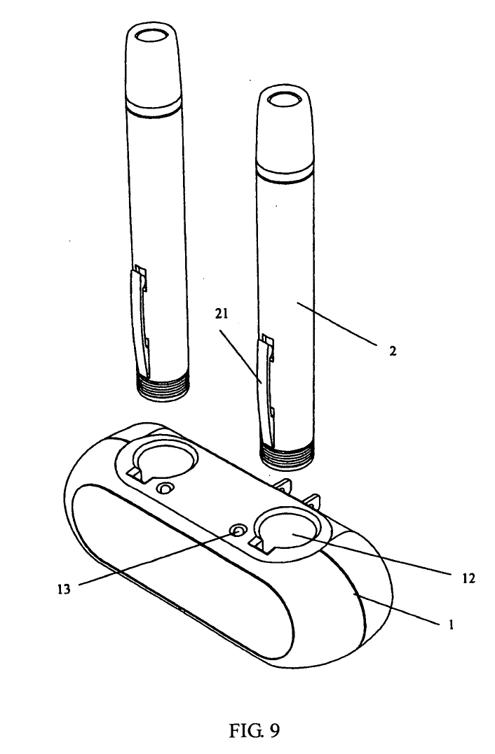

As shown in FIGS. 1 to 9, the dedicated charger socket for hand-held pen-shaped spotlights 1 according to the present invention comprises a pair of alternating current (AC) connector pins 11 capable of being directly inserted into a commercial power supply jack, and two recessed grooves 12 adapted in shape to the hand-held pen-shaped spotlights 2 so as to charge the hand-held pen-shaped spotlights 2. Two charging indicator lamps 13 are provided so as to correspond to the two recessed grooves 12 respectively.

Corresponding to the two recessed grooves 12, two hand-held pen-shaped spotlights 2 are provided. A clip 21 is provided on each of the hand-held pen-shaped spotlights 2.

Since the dedicated charger socket for hand-held pen-shaped spotlights 1 according to the present invention has two recessed grooves 12 so as to adapt to and charge two hand-held pen-shaped spotlights 2 simultaneously, a user can use the two hand-held pen-shaped spotlights 2 conveniently, alternatively and continuously, that is, when one of the two hand-held pen-shaped spotlights 2 is used, the other thereof can be charged, so that the hand-held pen-shaped spotlight 2 can be kept in the brightest operating state, or the two hand-held pen-shaped spotlights 2 can be used simultaneously by two users respectively. By comparison, the conventional dedicated charger socket only charge one hand-held pen-shaped spotlight once and there is only one hand-held pen-shaped spotlight adapted to the dedicated charger socket.

Further, since an indicator lamp 13 is provided so as to correspond to each of the two recessed grooves 12, the charging state of each recessed groove 12 can be indicated conveniently.

The hand-held pen-shaped spotlights and the dedicated charger socket therefor according to the present invention can provide illumination conveniently, alternatively and continuously, and the hand-held pen-shaped spotlights can always be kept in the brightest operating state.

Although embodiments of the present invention have been shown and described, it will be appreciated by those skilled in the art that changes my be made in these embodiments without departing from the principles and spirit of the invention, the scope of which is defined in the appended claims and their equivalents.

What is claimed is:

1. A dedicated charger socket for hand-held pen-shaped spotlights, comprising:
a base;
a charging body connected fixedly to the base;
an inner chamber provided with a transformer and a charging circuit arrangement therein; alternating current (AC) connector pins capable of being directly inserted into a commercial power supply jack; and
two recessed grooves adapted to hand-held pen-shaped spotlights so as to charge the hand-held pen-shaped spotlights.

2. The dedicated charger socket for hand-held pen-shaped spotlights according to the claim 1, wherein a charging indicator lamp is provided so as to correspond to each of the two recessed grooves.

3. A hand-held pen-shaped spotlight charged by using the dedicated charger socket according to the claim 1, wherein the number of hand-held pen-shaped spotlight is two.
